(19) United States
(12) Patent Application Publication
(10) Pub. No.: US 2008/0243640 A1
(43) Pub. Date: Oct. 2, 2008

(54) INTERACTIVE PRODUCT AND METHOD OF FABRICATING THE SAME

(75) Inventor: Jennifer Anne PARETTA, Wantagh, NY (US)

Correspondence Address: NIXON PEABODY, LLP, 401 9TH STREET, NW, SUITE 900, WASHINGTON, DC, 20004-2128, US

(73) Assignee: THE FRIENDSHIP GIFT BAG COMPANY, LLC, Wantagh, NY (US)

(21) Appl. No.: 12/057,047

(22) Filed: Mar. 27, 2008

Related U.S. Application Data
(60) Provisional application No. 60/908,385, filed on Mar. 27, 2007.

(51) Int. Cl. G06F 17/30

(52) U.S. Cl. 705/27

(57) ABSTRACT

A method of producing a web interactive product is provided including registering a product having a unique identification with an affiliate via the internet. A design portion of the product may be altered by a first recipient. Thereafter, the altered product is forwarded to one or more other recipients wherein the design portion may be re-altered by each of the recipients. A final recipient forwards the re-altered design portion to an affiliate. The first recipient and one or more other recipients may be registered with the affiliate based on the unique identification via the internet. All recipients may be notified via the internet that the re-altered design portion is received by the affiliate. The method may further include providing a means for ordering a final product including the re-altered design portion from the affiliate via the internet.

### CROSS REFERENCE TO RELATED DOCUMENTS

This application claims priority to provisional U.S. patent application entitled, “Friendship Gift Bag”, filed Mar. 27, 2007, having Ser. No. 60/908,385, the disclosure of which is hereby incorporated by reference in its entirety.

### TECHNICAL FIELD

The invention relates generally to an interactive product and, more particularly, to an item designed to promote creativity and an opportunity to track the gift-giving experience.

### BACKGROUND OF THE INVENTION

Gift items are generally given to individuals or groups, such as during special occasions, including, for example, birthdays, holidays, anniversaries, commemorations, etc. Usually such gift items are presented to the recipient(s) as a one time event. Moreover, such gift items may be presented, for instance, in a selected wrapping or enclosed within a retainer, and/or carrier, in which the wrapping, retainer, or carrier is generally disposed of after the gift item is removed therefrom. Thus, the discarded amounts of wrappings retainers, and/or carriers, for example, may contribute to the vast amounts of wasted products particularly contrary to providing or contributing to efforts to promote a “green” society.

Even more, many gift item designs are generic, limited in selection, or simply not capable of being acclimated to the recipient's preferences upon receipt. Such preferences may include, for example, preferred colors, shapes, materials, and a host of other characteristics contributing to a preferred design of the item by the recipient.

Accordingly, the present disclosure is directed towards overcoming one or more shortcomings set forth above.

### SUMMARY OF THE INVENTION

It is, therefore, one object of the present invention to overcome the deficiencies of the prior art and to provide a method of producing a web interactive product including registering a product having a unique identification with an affiliate via the internet. A design portion of the product may be altered by a first recipient. Thereafter, the altered product is forwarded to one or more other recipients wherein the design portion may be re-altered by each of the recipients. A final recipient forwards the re-altered design portion to an affiliate. The first recipient and one or more other recipients may be registered with the affiliate based on the unique identification via the internet. All recipients may be notified via the internet that the re-altered design portion is received by the affiliate. The method may further include providing a means for ordering a final product including the re-altered design portion from the affiliate via the internet.

In accordance with another disclosed exemplary embodiment, a system for producing a web interactive product may include a means for registering a product having a unique identification with an affiliate via the internet, a means for altering a design portion of the product by a first recipient, a means for forwarding the altered product to one or more other recipients, and a means for re-altering the design portion of the altered product by one or more other recipients. The system may further include a means for forwarding the re-altered design portion by a final recipient to the affiliate and a means for registering the first recipient and one or more of the other recipients with the affiliate based on the unique identification via the internet. A means for notifying all recipients of the re-altered design portion once received by the affiliate via the internet, and a means for ordering a final product including the re-altered design portion from the affiliate via the internet may also be provided.

In accordance with yet another disclosed exemplary embodiment, a method of producing an interactive product may include registering a product having a design portion with an affiliate, altering the design portion of the product by a first recipient, and forwarding the altered product to one or more other recipients. The method may further include re-altering the design portion of the altered product by one or more other recipients, forwarding the re-altered design portion by a final recipient to the affiliate, and generating a final product including the re-altered design portion received by said affiliate.

In accordance with yet another disclosed exemplary embodiment, a method of producing a web interactive product may include registering a product having a unique identification with an affiliate, altering a design portion of the product by a first recipient, and forwarding the altered product to one or more other recipients. The method may further include re-altering the design portion of the altered product by one or more other recipients and forwarding the re-altered design portion by a final recipient to said affiliate. Further, the method may also include registering the first recipient and one or more of the other recipients with the affiliate based on the unique identification, notifying all recipients of the re-altered design portion once received by the affiliate via the internet, and providing a means for ordering a final product including the re-altered design portion from the affiliate.

In accordance with yet another disclosed exemplary embodiment, a method of producing a web interactive product may include registering a product having a unique identification with an affiliate via the internet altering a design portion of the product by a recipient, and forwarding the altered design portion to the affiliate. The method may further include registering the recipient with the affiliate based on the unique identification via the internet, notifying the recipient of the altered design portion once received by the affiliate via the internet, and providing a means for ordering a final product including the altered design portion from the affiliate via the internet.

### BRIEF DESCRIPTION OF THE DRAWINGS

FIG. 1 is a schematic illustration of a product lifecycle according to an exemplary disclosed embodiment;

FIG. 2 provides a diagrammatic view of a product gift bag according to an exemplary disclosed embodiment;

FIG. 3 provides another schematic illustration of a product lifecycle according to another exemplary disclosed embodiment;

FIG. 4 provides a diagrammatic view of a keepsake item according to an exemplary disclosed embodiment; and

FIG. 5 provides a diagrammatic view of another keepsake item according to an exemplary disclosed embodiment.

### DETAILED DESCRIPTION OF THE INVENTION

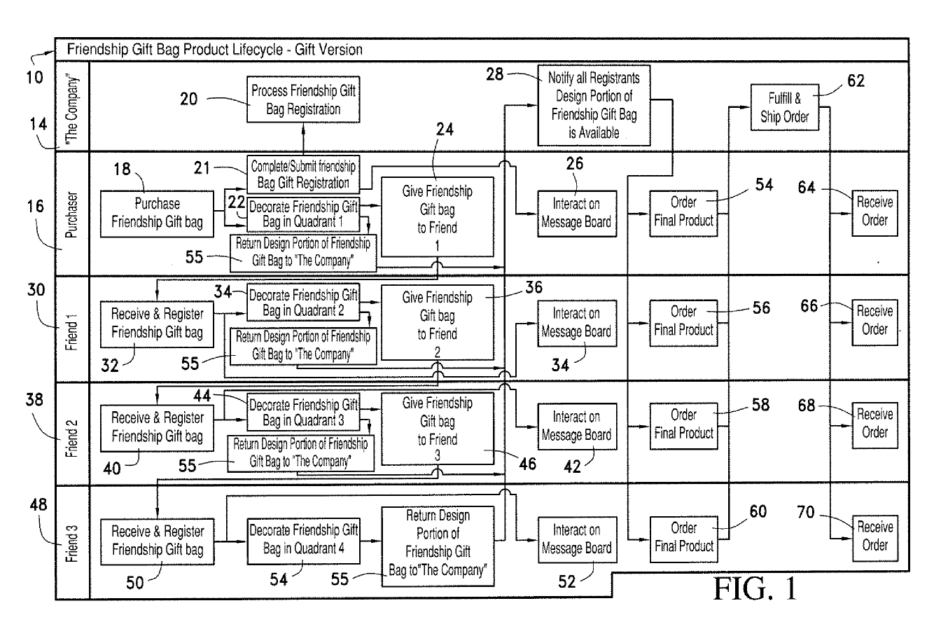

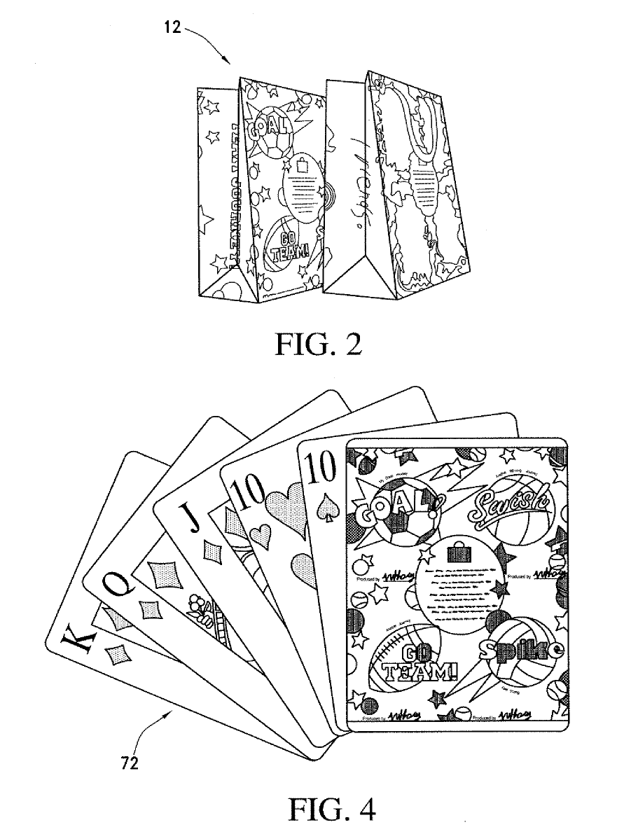

Referring to FIG. 1 a schematic illustration 10 of a lifecycle for a product is shown in accordance with an exemplary embodiment. In one disclosed embodiment, the product may include a gift bag 12 (e.g., see FIG. 2) which may be utilized to receive one or more gift items and/or be utilized as a gift itself. The gift bag 12 is preferable designed to be durable and capable of retaining sufficient weight of gift items. For example, in one exemplary embodiment, the gift bag 12 may be designed, but not limited to, a 10″l×13″h×5″w dimension. The gift bag 12 may include a polypropylene outer packaging and be display ready. Additionally, a design of the gift bag 12 may include a carrying handle. According to disclosed embodiments, the gift bag 12 is meant to serve as a gift bag to promote friendship, wherein it is further meant to be reused, recycled, and/or “re-gifted” among one or more friends or participants as further explained below.

The gift bag 12 may be provided by an entity or retailer such as The Friendship Gift Bag Company LLC. Accordingly, in an exemplary embodiment, the gift bag 12 (or “Friendship Gift Bag™” provided, for example, by The Friendship Gift Bag Company LLC) is purchased 18, wherein the purchaser 16 completes and submits the “Friendship Gift Bag™” registration 21 to an entity, such as a third party affiliate or company 14. Each “Friendship Gift Bag™” is associated with a unique identification, such as a number or other appropriate symbol uniquely affiliated with each respective gift bag 12. The unique identification is forwarded to the company 14 and is further processed 20 in order to track and provide information regarding a specific gift bag 12 as discussed below. The registration process 20, 21 may include any suitable manner for forwarding information such as via mail, internet, phone, mobile device or other appropriate electronic means capable of forwarding the identification of the respective gift bag 12 to the company 14.

After the product or gift bag 12 is registered to the purchaser 18, the purchaser 18 is in communication with the company 14 such as via interaction on a message board 26 including, for example, an e-mail system. Thus, the company 14 will have the capability to provide notification 28 to all registrants for a particular gift bag 12 in order to inform the registrants that a portion or all of the gift bag 12 design is available for ordering as further explained below. The purchaser 18 will have an opportunity to receive the final product back after the initial gift bag 12 is passed on to, and utilized by, an unknown number of people. These people may include participants, such as friends, family members and/or associates. Each participant is given an opportunity to create, write, and/or draw, such as in designated areas of the gift bag 12. Hence, a process of the disclosed invention includes the purchaser 18 registering the gift bag 12 and performing a decorating step 22, for example, by writing a message or drawing a design on the gift bag 12.

The purchaser 18 may then engage in a forwarding step 24 by giving the decorated gift bag 12 as part of, or exclusively as, a gift to a first participant, for example, a first friend 30. After receiving the gift bag 12, the first participant may register the gift bag 12 with the third party affiliate or company 14. This registration process 32 provides updated information to the company 14 including, for instance, the current location and current owner of the respectively registered gift bag 12. After the gift bag 12 is registered and updated by the first participant, the first participant is also linked in communication with the company 14 such as via interaction on a message board 34 including, for example, an e-mail system. Thus, the company 14 will have the capability to provide notification 28 to all registrants for a particular gift bag 12 in order to inform the registrants that a portion or all of the gift bag 12 design is available for ordering as further explained below.

The first participant or first friend 30 may, in turn, perform a decorating step 34 including, for example, writing their own message, drawing, and/or creating their own design, such as in a designated area of the gift bag 12. Once decorated, the first participant may engage in another forwarding step 36 by giving the decorated gift bag 12 as part of, or exclusively as, a gift to a second participant, for example, to a second friend 38. After receiving the gift bag 12, the second participant may register the gift bag 12 with the third party affiliate or company 14. This registration process 40 provides additional updated information to the company 14 including, for instance, the current location and current owner of the respectively registered gift bag 12. After the gift bag 12 is registered and updated by the second participant, the second participant is also linked in communication with the company 14 such as via interaction on a message board 42 including, for example, an e-mail system. Thus, the company 14 will have the capability to provide notification 28 to all registrants for a particular gift bag 12 in order to inform the registrants that a portion or all of the gift bag 12 design is available for ordering as further explained below.

The second participant or second friend 38 may, in turn, perform a decorating step 44 including, for example, writing their own message, drawing, and/or creating their own design, such as in a designated area of the gift bag 12. Once decorated, the second participant may engage in another forwarding step 46 by giving the decorated gift bag 12 as part of, or exclusively as, a gift to a third participant, for example, to a third friend 48. After receiving the gift bag 12, the third participant may register the gift bag 12 with the third party affiliate or company 14. Again, this registration process 50 provides additional updated information to the company 14 including, for instance, the current location and current owner of the respectively registered gift bag 12. After the gift bag 12 is registered and updated by the third participant, the third participant is also linked in communication with the company 14 such as via interaction on a message board 52 including, for example, an e-mail system. Thus, the company 14 will have the capability to provide notification 28 to all registrants for a particular gift bag 12 in order to inform the registrants that a portion or all of the gift bag 12 design is available for ordering as further explained below.

The third participant or third friend 48 may, in turn, perform a decorating step 54 including, for example, writing their own message, drawing, and/or creating their own design, such as in a designated area of the gift bag 12. In the present embodiment, the third friend 48 is also the final friend who will, in this case, recycle and provide additional designs to the gift bag 12. Accordingly, after completion of the final design of the gift bag 12 by the final participant, the gift bag 12 is mailed back as a final product to the company 14.

It should be appreciated that the gift bag 12 originally forwarded by the purchaser 16 may include a limited number of design areas for a respective number of participants to design. The current embodiment describing and illustrating four design modifications to the gift bag 12 (e.g., FIG. 1's purchaser and friends 1-3) is merely presented as one example for designing and forwarding the gift bag 12 among a group of participants and eventually back to the company 14. More or less participants may receive and decorate the gift bag 12 until a final participant forwards the gift bag 12 back to the company 14. The design areas and number or participants who may be eligible to make designs on the disclosed gift bag 12 should not be limited to any specific number. Furthermore, the design areas of the disclosed gift bag 12 should also not be limited to any specific number. Thus, the design areas and/or the number of participants for designing a respective gift bag 12 are adjustable/variable according to prescribed design preferences.

In some embodiments, the design of the gift bag 12 may include altering the entire bag or designated areas of the gift bag 12 such as a front panel, or a side panel or a back panel by one or more participants. The aforementioned panels may be regarded as a finite number of quadrants, for example, listed as quadrants 1-4 corresponding to being designed by respective participants 1-4. The designated areas for design may also be regarded as one or more design portions. Again, in some embodiments, respective design portions may be assigned to respective recipients of the gift bag 12 to decorate. However, in another example, one or more respective recipients may design one or more design portions of the gift bag 12.

Once the gift bag 12 is mailed back as a final product to the company 14, every registrant is contacted by the company 14 informing them of the final status of the gift bag 12 in a notification process 28. Each registrant is allowed to view the final “Friendship Gift Bag™” design created as a result of the gift bag 12 journeying from the first to the last participant during its unique design process. Each registrant is capable of monitoring and tracking the gift bag 12 as it is registered and designed by each registrant throughout its journey to different participants. In the disclosed embodiment, the ability to track the gift bag 12 includes utilizing the personal registration identification associated with the gift bag 12 and communicating with the company 14, via the internet, such as on a secure web tool designed especially for a respective “Friendship Gift Bag™”. The purchaser 16 will then have the option to receive a final design of the originally forwarded “Friendship Gift Bag™” back by ordering it from the company 14 in a product ordering step 54. Additionally, and/or alternatively, the other registrants, e.g., friends 1, 2 and 3 (30, 38, and 48, respectively) may also order a copy of the final design of the unique gift bag 12 in respective ordering steps 56, 58, and 60.

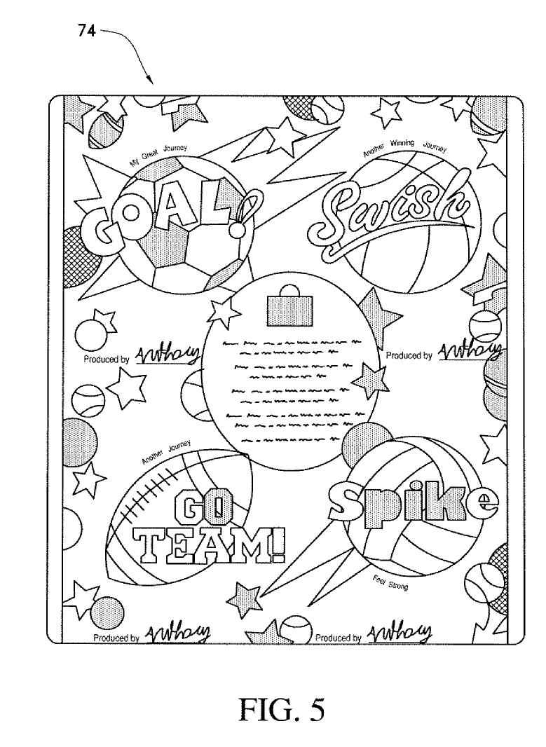

The final design of the unique “Friendship Gift Bag™” may be incorporated into keepsake items and made available by the company 14 to each registrant for ordering in the order processes 54, 56, 58, and 60. For example, turning to FIGS. 4 and 5, a deck of playing cards 72 and a mouse pad 74 incorporate the final design of an exemplary “Friendship Gift Bag™” on the surfaces thereof. Thus, the keepsake items may include a unique photo created from the design of the final “Friendship Gift Bag™”. Additional keepsake items offered by the company 14 may include key chains, clothing items, such as hats and t-shirts, bookmarks, pen holders, drinking utensils, such as coffee mugs, cups, glasses, and other items suitable for receiving a design formed on the “Friendship Gift Bag™”. In another example, the design formed on the “Friendship Gift Bag™” may be received as a photo which can be laminated or framed. Thus, all registrants are capable of creating and receiving a unique photo gift from the final “Friendship Gift Bag™” design. Additionally and/or alternatively, the uniquely created “Friendship Gift Bag™” may be ordered by the original purchaser 16 as an original work of art, framed art or laminated product. Due to the large number of sizes, shape and structure of bags this product can be designed many different ways incorporating an unlimited amount of friends/participants. Additionally, the gift bag 12 may be used for all occasions (e.g., holidays, birthdays, weddings, baby showers, etc.) with numerous amounts of designs for individual art, drawing, and/or message areas. Hence, once orders 54, 56, 58, and/or 60 have been placed, each order undergoes a fulfillment and shipping process 62 by the company 14 to fulfill the orders 64, 66, 68, and 70 as required.

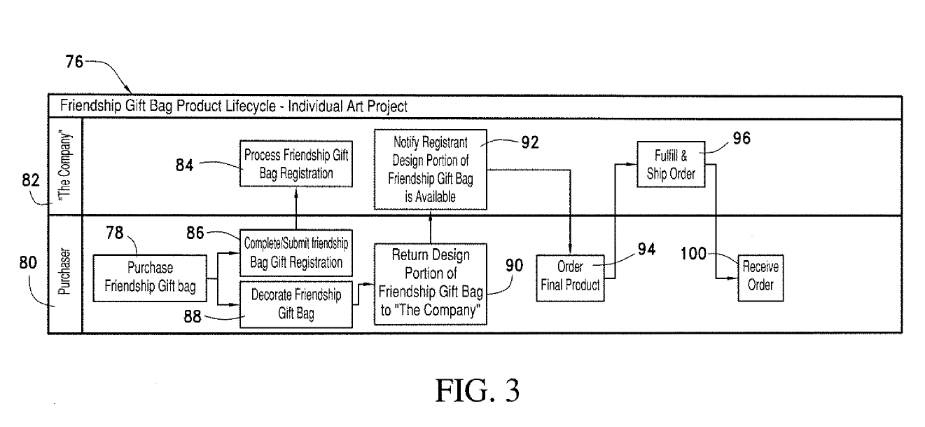

The product is may also be utilized as a craft/art book project in which any purchaser, for any occasion, can use the product as a means for participants such as friends and acquaintances to write messages or creates a design and/or drawing without necessarily reusing the product as a gift bag 12. Turning to FIG. 3 a schematic illustration 76 of a lifecycle for a product is shown, wherein the product is utilized as an individual art project.

In the disclosed embodiment, the product may include a gift bag 12 as previously described, for example, in FIG. 2. The gift bag 12 may be provided by an entity or retailer such as The Friendship Gift Bag Company LLC. Accordingly, in an exemplary embodiment, the gift bag 12 (or “Friendship Gift Bag™” provided, for example, by The Friendship Gift Bag Company LLC) is purchased 78, wherein the purchaser 80 completes and submits the “Friendship Gift Bag™” registration 84 to an entity, such as a third party affiliate or company 82. Each “Friendship Gift Bag™” is associated with a unique identification, such as a number or other appropriate symbol uniquely affiliated with each respective gift bag 12. The unique identification is forwarded to the company 82 in order to track and provide information regarding a specific gift bag 12 as discussed below. The registration process 84 may include any suitable manner for forwarding information such as via mail, internet, phone, mobile device or other appropriate electronic means capable of forwarding the identification of the respective gift bag 12 to the company 82.

The gift bag 12 may include a design portion suitable for being decorated in a manner as prescribed above. Thus, in addition to registering the product or gift bag 12, the purchaser 18 may decorate the gift bag 12 in a decoration step 88 as described above. Once decorated, the purchaser 80 may return the design portion of the gift bag 12 back to the company 82 in a return process 90. Upon receiving the design portion, the company provides notification 92 to the purchaser 80 of the receipt of the design.

The purchaser 80 may view the final design portion of the gift bag 12 and has an option of purchasing the same in an ordering step 94. In a similar manner as described above, the design portion, created by the purchaser 80, may also be incorporated into keepsake items and made available by the company 14 to the purchaser 80 for ordering in the order process 94. Once the ordering process 94 is complete, each order undergoes a fulfillment and shipping process 96 by the company 82 to fulfill the orders 100 as required.

An exemplary synopsis is provided for a transaction of the disclosed product of the invention interacting as a web product. Accordingly, a business may provide for free distribution and/or sale a product such as a gift bag 12 having a unique code which is passed from one person to another. Each person who receives the gift bag 12 may decorate the gift bag 12. In one embodiment, the decoration may including decorating a selected panel area of the gift bag 12 before utilizing and/or passing the gift bag 12 on. Thus, each recipient receiving the gift bag 12 may have an option of decorating one or more decorative panel areas. At each stage, the recipient may log into a website affiliated with a company to upload selected information to the company pertaining to the gift bag 12. The company may track the uploaded information and make the information available to recipients as further described below. Recipients may place a message on a message board, maintained by the company, regarding the gift bag 12 if they choose. This information is capable of being viewed by subsequent recipients when they log into the company's website. At any point in the journey, there is an option to send the gift bag 12 to the company. Accordingly, a recipient interacts with the company's website to indicate the return, whereupon, in one example, the website may be configured to provide a challenge message presented to the recipient such as, “Are you sure you wish to send the gift back—are you sure you have completed the journey?” If the recipient decides that the gift bag 12 is complete, they may cut out the fully decorated panel or panels decorated by all recipients and return it to the company wherein upon the completed panel or panels are processed by the company to provide a graphic from which merchandise is created, such as keepsake items. In one embodiment, the processing may include scanning the received panel or panels to create the graphic. However, any suitable process or equipment may be utilized for creating the graphic to produce merchandise.

In one embodiment, the gift bag 12 and other merchandise may be available by ordering through the website, such as via an x-cart shopping cart set up, and purchased via a client merchant account, such as a Pay Pal® merchant account. Gift bag recipients can go to the website and register the gift bag 12 and log in giving their prescribed information and using the unique identifier on the gift bag 12. The website may incorporate security information such as a “Date of Birth” screen, wherein persons under 18 must use a parental e-mail address. Other screen details may include, “First Name”, “Last Name”, “Town”, “State”, “Valid E-Mail Address”, “Journey Title” (can be anything, such as “Joey's Journey!”), “Bag ID Code registration number”. Upon completion and subsequent validation of the aforementioned exemplary information the website may confirm the details and present a new screen requiring additional information. This, for example, may include “Choose user name” and “Select Password”.

The life cycle of the gift bag 12 or “Friendship Gift Bag™” of the disclosed invention is monitored so that all recipients can track its progress to other recipients at any time. Each e-mail address is preferably verified as a working address so that notification of the end of the journey can be sent. In order to ensure working e-mail addresses, all registrants may be sent an e-mail to the submitted address (forwarded by the recipient during registration) with a confirmation link included in the e-mail. By clicking the confirmation link, the website is able to verify that a valid e-mail exists. Hence, the website may be configured to forward a customized message such as “Anthony has registered his bag # B180gf15 and you must verify receipt by clicking HERE . . . ”

Upon proper setup, the first user of the bag can now log in with their respective user name and password. They will be directed to a “journey” page with their respective details already filled out, including, for example, specific personal information. Moreover, they will also be able to register other gift bags 12 under the same account. When a user logs in to the website, they will see a list of all of their journeys in progress from which they will be able to select. In one embodiment, the journeys are listed by title, bag number, and start date.

The journey tracking ability provided by the website, in accordance with the invention, provides users with the ability to log in and add messages to the “journey” page. Additionally, users are able to log in at any time to check the progress of a particular journey. The tracking ability of the website also provides for recipients who may decline to log into the website and/or do not input their details. In this case, the next recipient who decides to login and register will simply take their place.

The website may also be suitably configured to track when new users log in and inform prior registrants from the same journey, such as via e-mail, to tell them that the gift bag 12 has a new recipient and that they should log on to see the location of the gift bag 12 and the current recipient. At any time, if any participant logs in, they will be notified of any new registrants and updates to the journey. When the final user registers, a “near completion” e-mail may be sent out to remind all registered recipients of the journey, and to encourage the final user to follow the instructions and send in the finished bag for publication. The final user can go back to the website and print out a pre-paid mailing label for free return postage.

At journey's end, all participants will be notified, e.g., via e-mail, of the completion of the gift bag 12. Each participant will also be invited to log back into the website in order to view the completed gift bag 12, order copies of the gift bag 12 or other merchandise created from the graphic design of the gift bag 12 as described above.

In some embodiments, the disclosed product is a gift bag that is meant to be interactively tracked and passed among participants, such as friends, associates, and/or colleagues, when giving exclusively as a gift or as part of a gift or occasion. The product of the invention is designed to allow each participant to adopt key life values and principles of reuse and recycling while promoting growth in a “green” society. The disclosed “Friendship Gift Bag™” is an interactive product that encourages one to respect each others belongings while enabling creativity with an underlying mission of promoting environmentally-friendly concepts. This product compliments the initiative to promote a greener society with utilizing products, such as gift bags, as a means of allowing participants to creative, reuse, recycle, and respect taking care of someone belongings. The “Friendship Gift Bag™” will ultimately be returned to the original purchaser who has the option to have the final creation framed or laminated. In addition, all participants will additional have the option to create a unique photo gift from the final “Friendship Gift Bag™” design.

The above-described devices and subsystems of the exemplary embodiments of FIGS. 1 and 3 can include, for example, any suitable servers, workstations, PCs, laptop computers, PDAs, Internet appliances, handheld devices, cellular telephones, wireless devices, and the like, capable of performing the processes of the exemplary embodiments of FIGS. 1 and 3. The devices and subsystems of the exemplary embodiments of FIGS. 1 and 3 can communicate with each other using any suitable protocol and can be implemented using one or more programmed computer systems or devices.

One or more interface mechanisms can be used with the exemplary embodiments of FIGS. 1 and 3, including, for example, Internet access, telecommunications in any suitable form (e.g., voice, modem, and the like), wireless communications media, and the like. For example, the employed communications networks can include one or more wireless communications networks, cellular communications networks, 3G communications networks, Public Switched Telephone Network (PSTNs), Packet Data Networks (PDNs), the Internet, intranets, or a combination thereof.

It is to be understood that the devices and subsystems of the exemplary embodiments of FIGS. 1 and 3 are for exemplary purposes, as many variations of the specific hardware and/or software used to implement the exemplary embodiments are possible, as will be appreciated by those skilled in the relevant art(s). For example, the functionality of one or more of the devices and subsystems of the exemplary embodiments of FIGS. 1 and 3 can be implemented via one or more programmed computer systems or devices.

To implement such variations as well as other variations, a single computer system can be programmed to perform the special purpose functions of one or more of the devices and subsystems of the exemplary embodiments of FIGS. 1 and 3. On the other hand, two or more programmed computer systems or devices can be substituted for any one of the devices and subsystems of the exemplary embodiments of FIGS. 1 and 3. Accordingly, principles and advantages of distributed processing, such as redundancy, replication, and the like, also can be implemented, as desired, to increase the robustness and performance the devices and subsystems of the exemplary embodiments of FIGS. 1 and 3.

The devices and subsystems of the exemplary embodiments of FIGS. 1 and 3 can store information relating to various processes described herein. This information can be stored in one or more memories, such as a hard disk, optical disk, magneto-optical disk, RAM, and the like, of the devices and subsystems of the exemplary embodiments of FIGS. 1 and 3. One or more databases of the devices and subsystems of the exemplary embodiments of FIGS. 1 and 3 can store the information used to implement the exemplary embodiments of the present invention. The databases can be organized using data structures (e.g., records, tables, arrays, fields, graphs, trees, lists, and the like) included in one or more memories or storage devices listed herein. The processes described with respect to the exemplary embodiments of FIGS. 1 and 3 can include appropriate data structures for storing data collected and/or generated by the processes of the devices and subsystems of the exemplary embodiments of FIGS. 1 and 3 in one or more databases thereof.

All or a portion of the devices and subsystems of the exemplary embodiments of FIGS. 1 and 3 can be conveniently implemented using one or more general purpose computer systems, microprocessors, digital signal processors, micro-controllers, and the like, programmed according to the teachings of the exemplary embodiments of the present invention, as will be appreciated by those skilled in the computer and software arts. Appropriate software can be readily prepared by programmers of ordinary skill based on the teachings of the exemplary embodiments, as will be appreciated by those skilled in the software art. In addition, the devices and subsystems of the exemplary embodiments of FIGS. 1 and 3 can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware circuitry and/or software.

Stored on any one or on a combination of computer readable media, the exemplary embodiments of the present invention can include software for controlling the devices and subsystems of the exemplary embodiments of FIGS. 1 and 3, for driving the devices and subsystems of the exemplary embodiments of FIGS. 1 and 3, for enabling the devices and subsystems of the exemplary embodiments of FIGS. 1 and 3 to interact with a human user, and the like. Such software can include, but is not limited to, device drivers, firmware, operating systems, development tools, applications software, and the like. Such computer readable media further can include the computer program product of an embodiment of the present invention for performing all or a portion (if processing is distributed) of the processing performed in implementing the exemplary embodiments of FIGS. 1 and 3. Computer code devices of the exemplary embodiments of the present invention can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the exemplary embodiments of the present invention can be distributed for better performance, reliability, cost, and the like.

As stated above, the devices and subsystems of the exemplary embodiments of FIGS. 1 and 3 can include computer readable medium or memories for holding instructions programmed according to the teachings of the present invention and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave, or any other suitable medium from which a computer can read.

It will be apparent to those skilled in the art that various modifications and variations can be made in the disclosed apparatus and method without departing from the scope of the disclosure. Additionally, other embodiments of the apparatus and method will be apparent to those skilled in the art from consideration of the specification. It is intended that the specification and examples be considered as exemplary only, with a true scope of the disclosure being indicated by the following claims and their equivalents.

What is claimed is:

1. A method of producing a web interactive product, comprising:
registering a product having a unique identification with an affiliate via the internet;
altering a design portion of said product by a first recipient;
forwarding said altered product to one or more other recipients;
re-altering said design portion of said altered product by one or more other recipients;
forwarding the re-altered design portion by a final recipient to said affiliate;
registering said first recipient and one or more of said other recipients with said affiliate based on said unique identification via the internet;
notifying all recipients of the re-altered design portion once received by said affiliate via the internet; and
providing the means for ordering a final product including the re-altered design portion from the affiliate via the internet.

2. The method of claim 1, further comprising:
monitoring a status of the altered product forwarded to said one or more other recipients via the internet.

3. The method of claim 2, wherein said monitoring includes reviewing the name and address of said one or more other recipients.

4. The method of claim 1, wherein forwarding said altered product to one or more other recipients includes forwarding the product as part of or exclusively as a gift item.

5. The method of claim 1, further comprising:
communicating through the affiliate via the internet with one or more of the recipients based upon said unique identification of said product.

6. The method of claim 1, wherein said product includes a gift bag.

7. The method of claim 1, wherein said final product includes one of a gift bag and another product different from said gift bag.

8. The method of claim 7, wherein said another product includes one of a key chain, a mouse pad, a clothing item, a bookmark, a pen holder, a photo, a framed or unframed art piece, and a drinking utensil.

9. The method of claim 1, wherein said altering and re-altering said design portion includes at least one of drawing, writing, and coloring said design portion.

10. A system for producing a web interactive product, comprising:
means for registering a product having a unique identification with an affiliate via the internet;
means for altering a design portion of said product by a first recipient;
means for forwarding said altered product to one or more other recipients;
means for re-altering said design portion of said altered product by one or more other recipients;
means for forwarding the re-altered design portion by a final recipient to said affiliate;
means for registering said first recipient and one or more of said other recipients with said affiliate based on said unique identification via the internet;
means for notifying all recipients of the re-altered design portion once received by said affiliate via the internet; and
means for ordering a final product including the re-altered design portion from the affiliate via the internet.

11. The system of claim 10, further comprising:
means for monitoring a status of the altered product forwarded to said one or more other recipients via the internet.

12. The system of claim 11, wherein said means for monitoring includes an interactive website.

13. The system of claim 10, wherein said communicating means includes an internet message board.

14. A method of producing an interactive product, comprising:
registering a product having a design portion with an affiliate;
altering the design portion of said product by a first recipient;
forwarding said altered product to one or more other recipients;
re-altering said design portion of said altered product by one or more other recipients;
forwarding the re-altered design portion by a final recipient to said affiliate; and
generating a final product including the re-altered design portion received by said affiliate.

15. A method of producing a web interactive product, comprising:
registering a product having a unique identification with an affiliate;
altering a design portion of said product by a first recipient;
forwarding said altered product to one or more other recipients;
re-altering said design portion of said altered product by one or more other recipients;
forwarding the re-altered design portion by a final recipient to said affiliate;
registering said first recipient and one or more of said other recipients with said affiliate based on said unique identification;
notifying all recipients of the re-altered design portion once received by said affiliate via the internet; and
providing a means for ordering a final product including the re-altered design portion from the affiliate.

16. The method of claim 15, further comprising:
monitoring a status of the altered product forwarded to said one or more other recipients.

17. The method of claim 1, further comprising:
communicating through the affiliate with one or more of the recipients based upon said unique identification of said product.

18. A method of producing a web interactive product, comprising:
registering a product having a unique identification with an affiliate via the internet;
altering a design portion of said product by a recipient;
forwarding the altered design portion to said affiliate;
registering said recipient with said affiliate based on said unique identification via the internet;
notifying said recipient of the altered design portion once received by said affiliate via the internet; and
providing a means for ordering a final product including the altered design portion from the affiliate via the internet.

19. The method of claim 18, wherein said product includes a gift bag.

20. The method of claim 18, wherein said final product includes one of a gift bag and another product different from said gift bag.
